(19) United States
(12) Patent Application Publication
(10) Pub. No.: US 2017/0130951 A1
(43) Pub. Date: May 11, 2017

(54) Smart Bag

(71) Applicant: Elva Patricia Carrasco-Slind, Richmond, TX (US)

(72) Inventor: Elva Patricia Carrasco-Slind, Richmond, TX (US)

(21) Appl. No.: 14/934,480

(22) Filed: Nov. 6, 2015

(51) Int. Cl. F21V 33/00; A45C 3/02; F21V 23/04; A45C 3/06

(52) U.S. Cl. CPC F21V 33/0004; A45C 3/06; A45C 3/02; F21V 23/0442; F21V 23/0464; F21Y 2115/10

(57) ABSTRACT

The present invention provides an enclosed receptacle, such as a hand bag or luggage bag, with an internal lightning system. The internal lightning system allows a user to view the contents of the receptacle in dark surroundings and the internal lightning system is controlled automatically through an ambient light sensor. The receptacle is further provided with additional utilities like a battery charger, music player etc. in an organized and easily accessible manner.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention generally relates to bags and in particular to bags with an internal lightning system.

(2) Background of Invention

Bags are enclosed receptacles and include purses, handbags, suitcase, briefcase and diaper bags etc. Typically, the bag has more than one compartment for organizing items contained therein, but each compartment may contain more than one item, in particular handbags used by women typically contains multiple items kept unorganized in a bag. Searching for a required item could be bothersome, particularly during dark, wherein, the individual couldn't see within the bag and has to identify the object using senses of the touch. Thus, a need is appreciated for an internal lightning system for bags that could allow viewing the items within bag in dark surroundings.

Prior arts addressing the above issue includes a U.S. Pat. No. 6,186,640 issued to “Melina Typaldos” which discloses a design of purse which includes an internal lightening system which illuminates upon opening the bag and closes automatically on closing the bag.

U.S. Pat. No. 4,972,304 issued to “Ylla Robert N” discloses a hand bag with an internal lightning system and a switch to operate the lights.

U.S. Pat. No. 6,120,162 issued to “Salvatore Guerrieri” which discloses a magnetically actuated illumination system for a purse, knapsack or fanny pack. The system works to effectively control a battery operated light with magnet and reed switch turning the light off and on.

U.S. Pat. No. 7,246,915 issued to “Receptacle illuminating device” which discloses a flexible illuminating system for a handbag. The flexible lighting could be used to illuminate any compartment or area of the bag easily.

Although prior art is rich in bags with internal lightning system. However, such bags couldn't become popular due to their limited utility. People generally carry portable electronic devices, such as, a smart phone, which needs to be charged frequently, thus requiring a portable charger. Thus, a need is appreciated for a bag that besides the storage function could combine multiple utilities for the convenience of users and thus could be commercially advantageous.

As used herein the term bag connotes any enclosed receptacle and includes a purse, handbag, luggage bag, briefcase and the like.

### SUMMARY OF THE INVENTION

The present invention, therefore, has as its principal object to provide a bag with an internal lightning system.

Another object of the invention is that the internal lightning system could detect the dark surrounding and automatically turn ON.

Still, another object of the invention is that the internal lightning system allows viewing the contents of bag in dark.

An additional objective of present invention is that the bag combines multiple utilities for the convenience of the user.

Yet another object of present invention is that the bag is economic to manufacture and the design of bag is aesthetically pleasing.

Certain embodiments of present invention provides an enclosed receptacle, such as a hand bag, luggage bag or like with an internal lightning system which allows viewing the content of bag in dark surroundings. The internal lightning system comprises at least one LED or other light source coupled to the interior lining of the bag. Preferably, strips having more than one LED could be provided for sufficient lighting throughout the bag. The LED could be powered through a portable battery pack enclosed within the bag and the battery pack is preferably rechargeable.

In another embodiment, the battery pack enclosed within the bag could also be used to recharge external electronic devices, such as, a smart phone. Moreover, the bag could also include a recharging cable which could be extended from the bag to an electronic device for recharging.

In another embodiment, the bag further comprise a portable music player that could be used to play the music and powered using its own battery or the portable battery enclosed within bag.

In another embodiment, the bag further comprises an easily accessible pocket for a memory device, such as, a flash drive, wherein the flash drive could be easily stored and retrieved for use.

In another embodiment, the bag may further comprise a tracking device, such as, a GPS transmitter for tracking the location of the bag, in case, the bag goes missing or the bag is stolen.

Thus, the present invention provides a bag with an internal lightning system and multiple utilities in an easily accessible and organized manner that could make the life of user more convenient and thus making the invention commercially advantageous.

In addition to the various objects and advantages of the present invention described with some degree of specificity above, it should be obvious that additional objects and advantages of the present invention will become more readily apparent to those persons who are skilled in the relevant art from the following more detailed description of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is the rear view of the hand bag showing a recharging port for electronic device, an audio player and a removable flash drive.

FIG. 2 is the logo on the front face of the bag and showing the recharging port for bag's internal battery pack.

FIG. 3 shows multiple utilities combined with the handbag.

FIG. 4 is the battery charger showing the USB port for connecting the electronic device, LED battery status indicators and a power switch.

FIG. 5 is the retractable charging cord that could be extended to the electronic device for charging.

FIG. 6 shows a music player combined to the bag.

FIG. 7 shows the pocket for removably storing a flash drive.

FIG. 8 shows the flash drive that could be stored in the pocket as shown in FIG. 7.

### DETAIL DESCRIPTION OF THE INVENTION

The present invention provides a bag with an internal lightning system and combines multiple utilities in an organized and easily accessible manner for the convenience of the user.

Before explaining at least one embodiment of the invention in detail, it is to be understood that the invention is not limited in its application to the details of construction and the arrangements of the components set forth in the following description. The invention is capable of other embodiments and of being practiced and carried out in various ways. Also it is to be understood that the phraseology and terminology employed herein are for the purpose of description and should not be regarded as limiting.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

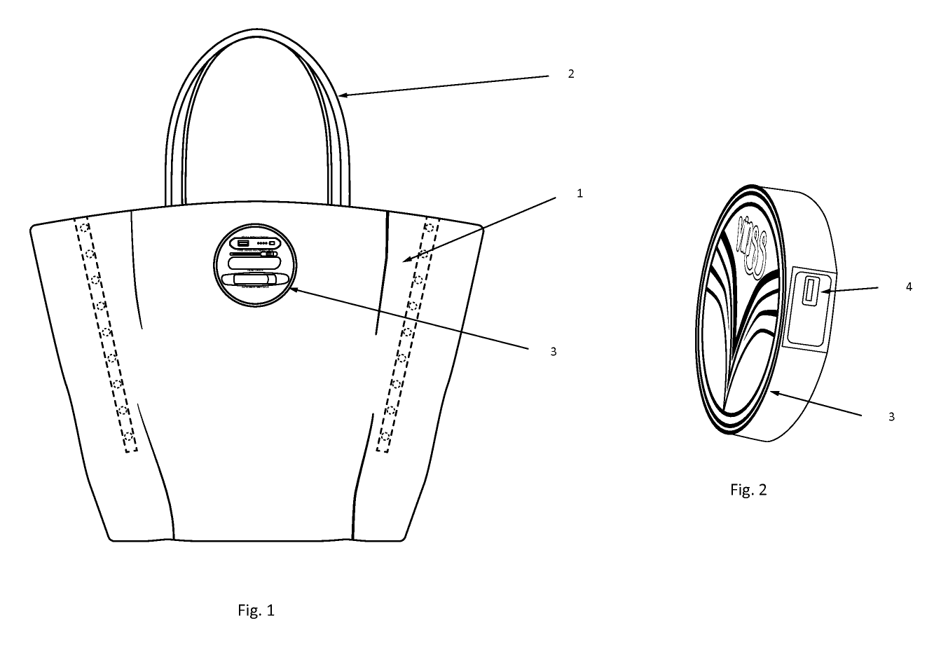

FIG. 1 is a hand bag 1 usually carried by women. The handbag has a front side, a back side, a bottom side, a left side and a right side which defines the volume of the bag. Two straps 2 coupled to front and back side is used to hold the bag. The bag has an internal lightning system which could be any light source obvious to as skilled person for lightning small volumes. Preferably LED's could be used and the lights could be a single light or a strip of light. One or more strip of lights could be coupled to different location in the bag depending upon the size and shape of the bag. The position and number of LED's could be such that interior volume of bag including the individual compartments is illuminated and the user could easily grasp the item required.

The internal lights could be automatically operated using sensors which get activated on opening the bag and detect the ambient light levels. The bag has a sensor to detect the open and close state of the bag. When the bag is open, the state sensor sends a signal to an ambient light sensor which detects the level of light within bag. The detected levels of lights are compared to the pre-programmed levels stored in the electronic system of bag. If the detected level of light exceeds the pre-programmed level, then the internal light source does not get activated. If the detected level of light is below the pre-programmed level, then the internal light source activates. A pre-set timer can be used in conjunction with the bag; the timer can shut off after a set period of time for convenience. The use of timer could have an advantage of shutting off the lights, in case, the sensors malfunction or could not detect the close state of the bag, which may otherwise lead to wastage of battery. The automatic process of illumination is convenient to user, as the user does not manually have to turn the lights ON and OFF every time. The lightning system may further include a manual override switch that may be used to override the automatic operation of light source by the sensors. The automatic lightning system could work normally when the manual override button is ON. However, when the switch is OFF, the lights are not turned ON automatically on opening the bag. Such a provision could be useful in place that requires dark conditions and lights could be a distraction, such as in a movie theatre.

The internal lightning system could be powered by a portable battery pack which could be enclosed within the housing. The battery pack could be of good capacity that runs for a long duration of time and does not require frequent charging. Moreover, the battery pack could be used to provide power output to other electronic devices such as for recharging of a smart phone. Preferably, the battery pack could be rechargeable. The battery pack could be enclosed within the inner lining and outer lining of the bag and all the electronic joints could be sealed within water proof packaging, thus, preventing any shock to the user. Moreover, the waterproof layer could also protect the battery, in case the bag gets wet. The battery could be charged using an appropriate external adaptor. The port for connecting the external charger could be provided in any convenient location, such as, shown in FIG. 2 which is logo 3 on the front side of bag and the recharging port 4 is provided on the side of the logo.

Besides internal lightning, the exterior of the bag may also be provided with illuminations, for example, the logo could have enclosed LED which when illuminated brightens up the logo. A strip of light could be provided on bag surface which could be illuminated in dark for providing unique aesthetic appearance to the bag. The external lights could also be powered by internal battery pack and could be manually controlled by the user. To further enhance the aesthetic value of the bag, the bag could be available in different designs and colors.

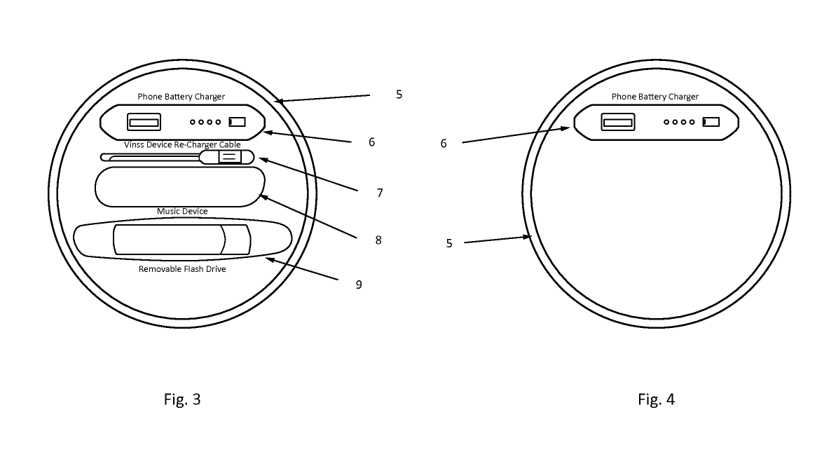

As shown in FIG. 1, the bag is combined with additional utilities 3, in an easy to reach and organized manner. In the figure, the back side of the bag has a disk like receptacle 5 which encloses different utilities, more clearly shown in FIG. 3. On the top is a battery charger 6, further shown clearly in FIG. 4. The battery charger could be used to charge external portable electronic device. The portable electronic devices are powered by batteries and require frequent charging, particularly smart phone. The user typically carries portable battery chargers commonly known as power banks. The current invention provides a battery charger in an easily accessible and convenient location, i.e. a bag. The battery charger could use internal battery of the bag or could have its own battery. Further, the battery charger could have LED indicators showing the status of the battery and a power button to start and stop the charging.

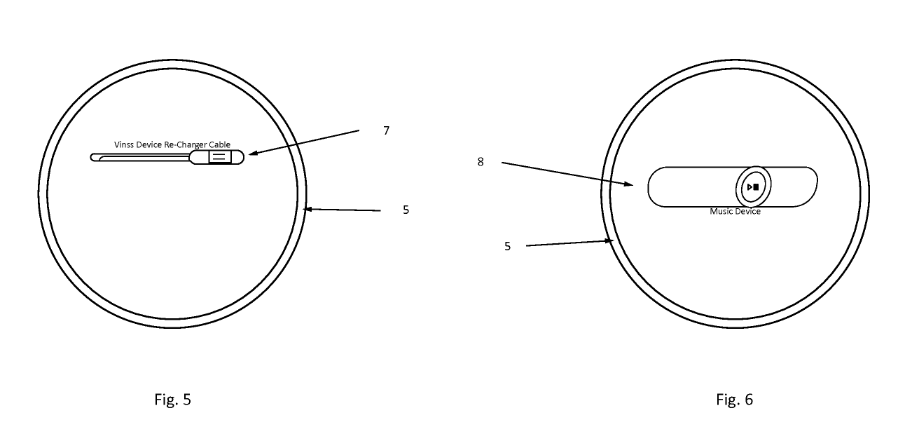

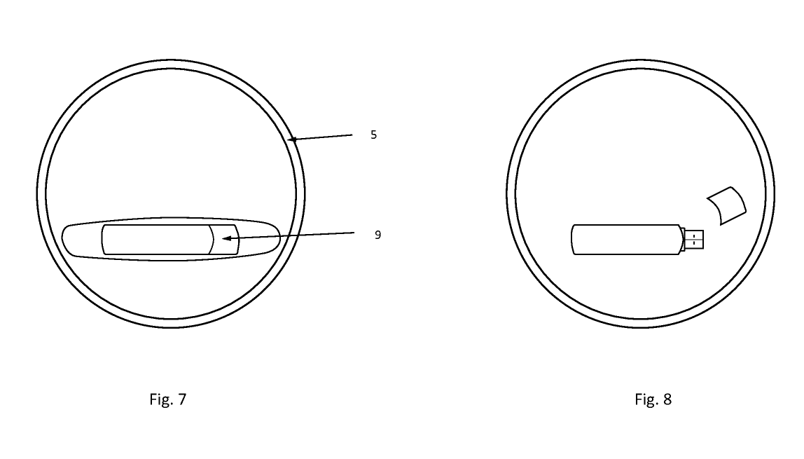

In FIG. 3, below the battery charger is a charging cable 7 more clearly shown in FIG. 5. The charging cable could be extended by pulling the cable and could be extended to the external electronic device for charging. After use, the cable could be retracted. Such a mechanism for refraction of cable using spring force or an electric motor is obvious to a skilled person.

Further, below the charging cable in FIG. 3 is a music player 8 which could be used for listening music using appropriate headphone. The music player could have all the functions of an ordinary music player, such as, play, pause, skip a track, volume control etc. The music player could have an in built memory or accepts external memory cards. The music player could be permanent or removably coupled to the bag. The music player could have its own battery or powered by an internal battery of the bag.

Also, the exterior of bag may contain a pocket 9 adapted to receive and hold a portable memory device, such as, a flash drive. The outer surface of the pocket could be transparent that may allow viewing the flash drive. Flash drives are good means to carry digital data and frequently used by a person. When the flash drive is within the bag, it may become bothersome to search for it within numerous items. Also, a person may not be sure whether he or she is carrying the flash drive. A transparent pocket for flash drive on the outer surface of bag could be convenient to the user and the user could easily assure that he is carrying the flash drive.

Further, the bag of current invention could also include a tracking device which may be used to locate the position of the bag, in case, the bag gets misplaced or the bag gets stolen. Since the bag generally contains money and other costly items, the bag is always susceptible to theft. Thus, it would be advantageous to include a tracking device in the bag that could save the user from economic loss as well as loosing other items such as identity documents etc. Moreover, the tracking device could also help the user to locate the bag in case the user simply forget the bag somewhere and does not remember, or the bag was dropped somewhere or the bag was left in a passenger vehicle. The tracking device is preferably installed between the linings of bag and hidden, such that the thief could not locate the tracking device and remove from the bag. The tracking device could be a GPS transmitter or any advanced form of GPS, such as A-GPS or cellular tracking. Furthermore, the user could track the position of the bag having a tracking device using their smart phone, laptop or use professional services to track and locate the bag. The technology and working of tracking devices is obvious to a skilled person.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

We claim:

1. A bag having an interior lining and an outer lining, said interior lining defines the interior volume of the bag, said bag comprising:
a. an illumination means adapted to couple to the interior lining of the bag for illuminating the interior volume of said bag;
b. a state sensor to detect an open and close state of bag;
c. an ambient light sensor enclosed within the bag to detect the light level in the bag, said ambient light sensor is operably coupled to the state sensor and the illumination means, when the bag is in open state as detected by said state sensor, the ambient light sensor detects the light level and if the detected light level are below the predetermined light levels, the ambient light sensors signals the illumination means to turn ON, when the bag is closed, the state sensor signals the illumination means to turn OFF;
d. a battery pack enclosed within the outer lining and the inner lining of said bag;
e. a battery charger coupled to the outer lining of the bag for powering an external electronic device, said battery charger is powered with said battery pack;
f. a music player coupled to the exterior lining of said bag; and
g. a pocket adapted to receive and hold a portable flash drive, said pocket is coupled to the outer lining of the bag.

2. The bag of claim 1, wherein said bag is a hand bag.

3. The bag of claim 1, wherein said bag is a luggage bag.

4. The bag of claim 1, wherein said bag is a briefcase.

5. The bag of claim 1, wherein said illumination means comprises at least one LED.

6. The bag of claim 1, wherein said external electronic device is a cellular phone.

7. The bag of claim 1, wherein said bag further comprise a timer circuit which turns off the illumination means after a predetermined period of time.

8. The bag of claim 1, wherein said bag further comprises a tracking device.

9. The bag of claim 1, wherein said bag further comprises a GPS transmitter for tracking the bag.

10. The bag of claim 1, wherein said bag further comprises a cellular tracking device.
